(19) United States
(12) Patent Application Publication
(10) Pub. No.: US 2011/0308731 A1
(43) Pub. Date: Dec. 22, 2011

(54) Adhesive Mass

(75) Inventors: Gabriel Dalmis, Hamburg (DE); Marc Husemann, Hamburg (DE)

(73) Assignee: TESA SE, Hamburg (DE)

(21) Appl. No.: 13/145,371

(22) PCT Filed: Jan. 14, 2010
(86) PCT No.: PCT/EP2010/050409

§ 371 Date: Sep. 8, 2011

(30) Foreign Application Priority Data
Jan. 29, 2009 (DE) 10 2009 006 591.1

(51) Int. Cl. C09J 193/04; B32B 37/12; C09J 7/02; B32B 7/12; B32B 33/00

(52) U.S. Cl. 156/332; 428/355 AC; 524/272; 428/41.8; 428/341

(57) ABSTRACT

The invention relates to an adhesive mass, comprising a mixture containing at least one ethylene vinyl acetate copolymer with an ethylene vinyl acetate component of 30 to 70 wt. % and a rosin/pentaerithritol resin with a softening range of 80° C. to 120° C., the resin component being between 20 and 40 wt. % based on the ethylene vinyl acetate copolymer, wherein the adhesive mass has a light transmission of at least 86% as per ASTM D 1003 and the adhesive mass has a Haze value of a maximum of 5% as per ASTM D 1003.

The invention relates to a pressure-sensitive adhesive formulation and the use thereof for bonds in the optically transparent range, more particularly for bonding optical components, preferably optical films.

The uses of PSAs are nowadays very diverse. In the industrial sector, accordingly, there exist a very wide variety of applications. Adhesive tapes based on PSAs are used in particularly high numbers in the electronics segment or in the consumer electronics segment. Owing to the high numbers of units, pressure-sensitive adhesive tapes can be deployed here very rapidly and easily. By contrast, other operations, such as riveting or welding, for example, would be too costly and complicated. Besides their normal joining function, these pressure-sensitive adhesive tapes may be required to take on additional functions. Examples thereof might include thermal conductivity, electrical conductivity or else an optical function. In the latter case, for example, pressure-sensitive adhesive tapes are used which fulfill light-absorbing or light-reflecting functions. Another optical function, for example, is the provision of a suitable light transmittance. Here, pressure-sensitive adhesive tapes and PSAs are used that are very transparent, have no intrinsic coloration, and possess a high light stability. Areas of application of such PSAs are, for example, the bonding of touch panels to an LCD or OLED display, or the bonding of ITO films (indium tin oxide) for capacitive touch panels.

In many cases, a PEA for optical applications, as well as the joining function, has the function of excluding air, since air has a refractive index of 1 and the optical films or glasses have a refractive index which is generally much higher. On transition from air to an optical component, the difference in refractive index leads to a reflection, by means of which the transmission is reduced. One possibility for reducing this problem is provided by antireflection coatings, which facilitate the transition of the light into the optical component, and reduce reflection. An alternative or additional option is to use an optical PSA with a refractive index similar to that of the optical component. This significantly reduces the reflection from the optical component, and increases the transmission.

Known overall are, for example, a large number of acrylate PSAs which have very different refractive indices and can be used for optically transparent applications. U.S. Pat. No. 6,703,463 B2 describes acrylate PSAs with a refractive index of below 1.40. This is achieved by fluorinated acrylate monomers. JP 2002-363523 A discloses acrylate PSAs having a refractive index of between 1.40 and 1.46. Here again, fluorinated acrylate monomers are used. Available commercially, moreover, are pressure-sensitive adhesive acrylate tapes, such as 3M 8141, for example, having a refractive index in the range from 1.47 to 1.48. US 2002/0098352 A1 in turn describes acrylate PSAs with aromatic comonomers. These acrylate PSAs have a refractive index of from 1.49 to 1.65. EP 1 652 889 A1 describes PSA formulations for optical applications that are based on polydiorganosiloxanes. Silicone compounds generally have a low refractive index.

Also known, furthermore, are a multiplicity of pressure-sensitive adhesives and pressure-sensitive adhesive tapes that are based on ethyl vinyl acetate copolymers. These, however, have only a relatively poor transparency or only low bond strengths, and so are of only limited usefulness for permanent adhesive bonds. Examples thereof are disclosed in EP 0315070 A2.

It is an object of the present invention to specify an alternative pressure-sensitive adhesive which is suitable especially for the adhesive bonding of optical components, thus having a high transparency. As far as possible, the pressure-sensitive adhesive ought additionally to have a high UV stability as well and to behave inertly in the context of adhesive bonding to electrically conductive substrates.

The present invention solves the above-described object through the provision of a pressure-sensitive adhesive as claimed in claim 1. A co-independent solution provides for the use of a pressure-sensitive adhesive as claimed in claim 11. Preferred embodiments and developments are subject matter of the respective subclaims.

Surprisingly it has emerged that it is possible, on the basis of ethylene-vinyl acetate copolymer, to prepare a pressure-sensitive adhesive which meets the desired requirements, being more particularly optically transparent and also having a high bond strength for permanent adhesive bonds. The preparation of a pressure-sensitive adhesive of this kind necessitates modifications with defined resins.

The invention accordingly provides a pressure-sensitive adhesive composed of a mixture at least comprising
an ethylene-vinyl acetate copolymer having a vinyl acetate fraction of 30-70 percent by weight
a rosin-pentaerythritol-based resin having a softening range of 80-120° C.,
   the resin fraction being between 20% and 40% by weight, based on the EVA copolymer, and the light transmittance of the pressure-sensitive adhesive formulation being greater than 86% and the haze being less than 5% in accordance with ASTM D 1003.

Besides the constituents described, the pressure-sensitive adhesive may in addition also comprise further constituents, examples being further polymers, further resins or else additives.

A pressure-sensitive adhesive (PSA) of this kind is suitable on account of its optical properties especially for the adhesive bonding of optical components such as glass, optically transparent films or the like. The PSA achieves more particularly a light transmittance to ASTM D 1003 of at least 86% and a haze value to ASTM D 1003 of not more than 5%. A further feature of a PSA of this kind is a high UV stability, and it also behaves inertly in the context of adhesive bonding to electrically conductive substrates.

As described, the adhesive used is one based on ethylene-vinyl acetate copolymers (EVA copolymers). The ethylene-vinyl acetate fraction in the adhesive is at least 30%, preferably at least 40%, by weight. Envisaged at the maximum is an ethylene-vinyl acetate fraction of 70% by weight, preferably of not more than 60% by weight. This PEA may comprise only one specific EVA copolymer, or instead mixtures of two or more EVA copolymers may be used. The ethylene-vinyl acetate copolymers may optionally also include up to 5% by weight of other comonomers as well—in this embodiment, therefore, the ethylene-vinyl acetate copolymers have a maximum fraction of 65% by weight. Hence monomers including acrylate monomers, for example, are possible comonomers.

Commercial examples of EVA copolymers are available, for example, from Lanxess under the trade name Levapren™, and also from ExxonMobil Chemical under the trade name Esocrene™.

Use is made as tackifying resins of partially or fully hydrogenated resins based on rosin and on rosin derivatives. Particular preference is given to using pentaerythritol versions of the rosins. The softening range is preferably between 80° C. and 120° C. Such resins are available from, for example, Arakawa Chemical Industries under the trade name Pinecrystal™. The fraction of the resin or mixtures of the aforementioned resin types, based on the EVA copolymer, is between 20% and 40% by weight.

Further additives that may typically be utilized include the following:
primary antioxidants, such as sterically hindered phenols, for example
secondary antioxidants, such as phosphites or thioethers, for example
in-process stabilizers, such as C radical scavengers, for example
light stabilizers, such as UV absorbers or sterically hindered amines, for example
processing assistants
fillers, such as, for example, silicon dioxide, glass (ground or in the form of beads), aluminum oxides or zinc oxides, the fillers preferably being ground to a sufficiently small size that they are optically invisible

As already elucidated above, there are particular requirements of optical adhesives in terms of their light stability. In order to meet these requirements, light stabilizers in particular are added to the (pressure-sensitive) adhesive. The addition of light stabilizers is made more particularly at a fraction from 0.1% to 2% by weight.

Light, stabilizers selected are preferably substituted triazines. The triazines are selected such that they have high compatibility with the EVA copolymers. This is achieved, for example, through substituents. Thus, preferred embodiments of the triazines have at least one aromatic substituent, more preferably two or more aromatic substituents and extremely preferably precisely three aromatic substituents. These aromatics may themselves also be substituted in turn by at least one aliphatic substituent. In its simplest form this may be a methyl group. However, other substituents are also possible, such as hydroxyl groups, ether groups, aliphatic chains having 2 to 20 C atoms, which may be linear, branched or cyclic and may in turn also contain 1 to 5 oxygen atoms in the form of ether groups, hydroxyl groups, ester groups and/or carbonate groups. Examples of light stabilizers of commercial nature are available from Ciba under the brand name Tinuvin®. Thus, for example, Tinuvin® 400, Tinuvin® 405, Tinuvin® 479, and Tinuvin® 477 are suitable triazines which can be used.

As light stabilizers, alternatively or additionally to the triazines, hindered amines can also be used. Particular preference is given to using substituted N-methylpiperidine derivatives. These are sterically hindered, for example, in position 1 and in position 5, by aliphatic groups, such as methyl groups, for example. It is particularly preferred to use four methyl groups for the steric hindrance. In order to achieve good solubility with the ethyl vinyl acetate copolymers and also in order to increase the evaporation temperature, long aliphatic substituents are used, by means of which solubility is improved. The substituents may be linear, cyclic or branched, may contain up to 20 C atoms and/or may contain up to 8 O atoms, which are in the form, for example, of ester groups, ether groups, carbonate groups or hydroxyl groups. For the effect it is possible to use compounds having only one N-methylpiperidine group. Also known, however, are dimeric N-methylpiperidine derivatives which have a light stabilizing function. These compounds may also be combined with the monomeric compounds.

As aging inhibitors it is preferred to use sterically hindered phenols. In one preferred embodiment, sterically hindered phenols have tert-butyl groups in both ortho-positions with respect to the hydroxyl group. In order to allow high solubility and a high evaporation temperature to be achieved, the sterically hindered phenols ought to have additional substitution. The substituents may be linear, cyclic or branched, may contain up to 20 C atoms and/or may contain up to 8 O atoms, which are in the form, for example, of ester groups, ether groups, carbonate groups or hydroxyl groups. Examples of commercially available compounds include Irganox® 1135 or Irganox® 1330 from Ciba.

The combination of substituted phenols and aromatically substituted phosphites has emerged as being particularly advantageous. The substituted phenols ought preferably to be at least doubly substituted and to contain at least one sulfur atom in both substituents. Commercial examples of S-containing sterically hindered phenols are Irganox® 1520 or Irganox® 1726 from Ciba. Commercial examples of aromatically substituted phosphites are Irgafos® 168, Irgafos® 126, Irgafos® 38, Irgafos® P-EPQ or Irgafos® 12 from Ciba.

Further details, objectives, features, and advantages of the present invention will be elucidated in more detail below by reference to preferred exemplary embodiments. In the drawing,

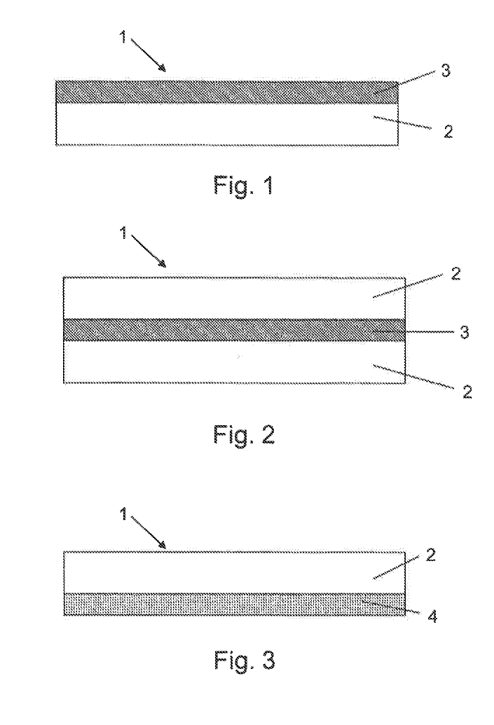

FIG. 1 shows a single-sided pressure-sensitive adhesive tape,

FIG. 2 shows a double-sided pressure-sensitive adhesive tape,

FIG. 3 shows a carrier-free pressure-sensitive adhesive tape (transfer tape),

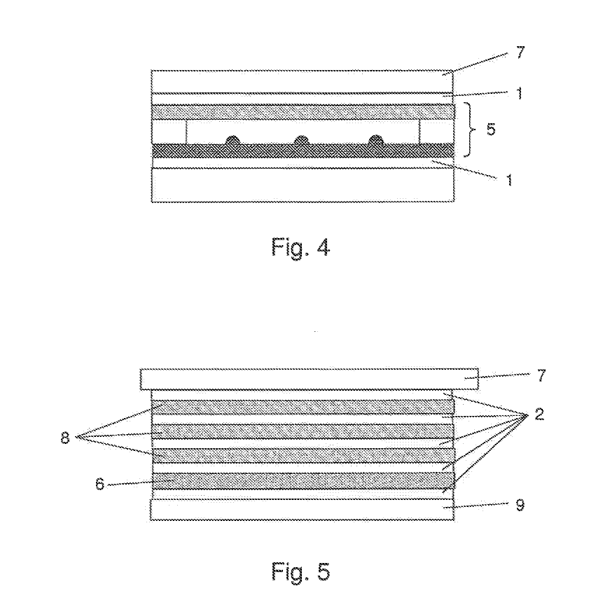

FIG. 4 shows the bonding of a rear reinforcement plate of a touch panel,

FIG. 5 shows the bonding of different layers of a touch panel.

### PRODUCT CONSTRUCTION

FIG. 1 shows a single-sided pressure-sensitive adhesive tape 1 for use in the bonding of optical components, more particularly of optical films. The pressure-sensitive adhesive tape 1 has an adhesive layer 2 produced by coating a PSA onto a carrier 3. The PSA coat weight is preferably between 5 and 250 g/m². The PSA is an adhesive having a mixture composed of ethylene-vinyl acetate copolymer and a rosin-based resin, as described above. The PSA has a transmittance of at least 86% in particular in the visible range of light, so making it particularly suitable for optical application.

For the application in the bonding of optical components, a transparent carrier 2 is also employed as carrier 2. The carrier 2 is therefore likewise transparent in the range of visible light, and hence preferably has a transmittance of—likewise—at least 86%.

Additionally provided (not shown) there may also be a release film which lines and protects the adhesive layer 2 prior to the use of the pressure-sensitive adhesive tape 1. The release film is then removed prior to the use of the adhesive layer 2.

The transparent PSA may preferably be protected with a release film. It is possible, furthermore, for the carrier film to be provided with one or more coatings. The PSA coat weight is preferably between 5 and 250 g/m².

The product construction depicted in FIG. 2 shows a pressure-sensitive adhesive tape 1 having a transparent carrier 3, which is coated on both sides with a PSA and thus has two adhesive layers 2. The PSA coat weight per side is again preferably between 5 and 250 g/m².

In this embodiment as well, it is preferred for at least one adhesive layer 2 to be lined with a release film. In the case of a rolled-up adhesive tape, this one release film may where appropriate also line the second adhesive layer 2. It is also possible, however, for a plurality of release films to be provided.

A further possibility is for the carrier film to be provided with one or more coatings. Moreover, only one side of the pressure-sensitive adhesive tape may be equipped with the inventive PSA, and a different transparent PSA may be used on the other side.

The product construction depicted in FIG. 3 shows a pressure-sensitive adhesive tape 1 in the form of a transfer tape, i.e., a carrier-free tape 1. For this purpose, the PSA is coated onto one side of a release film 4, and so forms a pressure-sensitive adhesive layer 2. The PSA coat weight is preferably between 5 and 250 g/m². Where appropriate, this pressure-sensitive adhesive layer 2 is also lined on its second side with a further release film. For the use of the pressure-sensitive adhesive tape, the release films are then removed.

As an alternative to release films it is also possible, for example, to use release papers or the like. In that case, however, the surface roughness of the release paper ought to be reduced, in order to produce a very smooth PSA side.

### Carrier Films

As carrier films it is possible to use a large number of highly transparent polymer films. Special highly transparent PET films can be used in particular. Suitability is thus possessed, for example, by films from Mitsubishi with the trade name Hostaphan™ of from Toray with the trade name Lumirror™. The haze, a measure of the clouding of a substance, ought in one preferred embodiment to have a value of less than 5% in accordance with ASTM D 1003. High haze denotes low visibility through the substance in question. The light transmittance at 550 nm is preferably greater than 86%, more preferably greater than 88%. A further very preferred species of the polyesters is represented by the polybutylene terephthalate films.

Besides polyester films it is also possible to use highly transparent PVC films. These films may include plasticizers in order to increase the flexibility. Moreover, PC, PMMA, and PS films can be used. Besides pure polystyrene, it is also possible to use other comonomers, such as butadiene, for example, in addition to styrene, for the purpose of reducing the propensity to crystallization.

Moreover, polyethersulfone films and polysulfone films can be used as carrier materials. These films are obtainable, for example, from BASF under the tradename Ultrason™ E and Ultrason™ S. It is also possible, furthermore, with particular preference, to use highly transparent TPU films. These films are available commercially, for example, from Elastogran GmbH. Use may also be made of highly transparent polyamide films and copolyamide films, and also of films based on polyvinyl alcohol and polyvinyl butyral.

Besides single-layer films it is also possible to use multilayer films, which are produced by coextrusion, for example. For this purpose it is possible to combine the aforementioned polymer materials with one another.

The films, further, may be treated. Thus, for example, vapor deposition may be performed, with zinc oxide, for example, or else varnishes or adhesion promoters may be applied. One further possible additization is represented by UV protectants, which may be present as additives in the film or may be applied as a protective layer.

The film thickness in one preferred embodiment of the invention is between 4 and 150 μm, more preferably between 12 and 100 μm.

The carrier film may, for example, also have an optical coating. Particularly suitable optical coatings are coatings which reduce the reflection. This is achieved, for example, through a reduction in the refractive index difference for the air/optical coating transition.

Generally speaking, a distinction may be made between single-layer and multilayer coatings. In the simplest case, MgF₂ is used as a single layer to minimize the reflection. MgF₂ has a refractive index of 1.35 at 550 nm. Furthermore, for example, metal oxide layers can be used in different layers to minimize the reflection. Typical examples are layers of SiO₂ and TiO₂. Examples of further suitable oxides include hafnium oxide (HfO₂), magnesium oxide (MgO), silicon monoxide (SiO), zirconium oxide (ZrO₂), and tantalum oxide (Ta₂O₅). It is additionally possible to use nitrides, such as SiNₓ, for example. Moreover, fluorinated polymer can be used as a low refractive index layer. These layers are also used very frequently in combination with the aforementioned layers of SiO₂ and TiO₂. Furthermore, sol-gel processes can be employed. Here, for example, silicones, alkoxides and/or metal alkoxides are used in the form of mixtures, and coating takes place with these mixtures. Siloxanes, therefore, are also a widespread basis for reflection-reducing layers.

The typical coating thicknesses are between 2 Å and 1000 Å, preferably between 100 Å and 500 Å. In some cases, depending on layer thickness and chemical composition of the individual or two or more optical layers, color changes occur, which may in turn be controlled or modified through the thickness of the coating. For the siloxane process coated from solution it is also possible to obtain layer thicknesses of greater than 1000 Å.

A further possibility for reducing the reflection lies in the production of particular surface structures. Hence there is the possibility of porous coating and of the generation of stochastic or periodic surface structures, in this case the distance between the structures ought to be significantly smaller than the wavelength range of visible light.

Besides the aforementioned process of solvent coating, the optical layers may be applied by vacuum coating methods, such as CVD (chemical vapor deposition) or PIAD (plasma ion assisted deposition), for example.

### Release Film

To protect the open (pressure-sensitive) adhesive it is preferably lined with one or more release films. As well as the release films it is also possible—albeit not very preferably—to use release papers, such as glassine, HDPE or LDPE release papers, for example, which in one embodiment have siliconization as a release layer.

It is preferred, however, to use a release film. In one very preferred embodiment the release film possesses siliconization as a release means. Furthermore, the film release liner ought to possess an extremely smooth surface, and so no structuring of the PEA is performed by the release liner. This is preferably achieved through the use of antiblocking-agent-free PET films in combination of silicone systems coated from solution.

### Coating

The pressure-sensitive adhesive may be coated from solution or from the melt. For coating from solution, the pressure-sensitive adhesive is dissolved in typical solvents, such as toluene, benzine, isopropanol, etc., and then coated via a coating nozzle or a doctor knife. Particular preference is given to manufacturing the pressure-sensitive adhesive from solution, in order to prevent premature crosslinking. However, it is also possible to use all other coating methods which allow solvent-containing coatings.

Furthermore, coating may also take place from the melt. In this case, for example, the pressure-sensitive adhesive is blended in a compounder or twin-screw extruder, mixed with all of the components, and then coating using, for example, an extrusion die or a melt die. In order to achieve a very high optical transparency, it is preferred to carry out coating under clean-room conditions.

### Use

The above-described (pressure-sensitive) adhesives and (pressure-sensitive) adhesive tapes are suitable particularly for use in optical applications, where preferably permanent bonds are performed with residence times of greater than one month.

One particularly preferred field of use encompasses the adhesive bonding of touch panels and also the production of touch panels. FIG. 4 shows typical adhesive bonds in resistive touch panels. For this purpose it is preferred to use (pressure-sensitive) adhesive transfer tapes, i.e., tapes without carriers. Top film or reinforcement plate, however, may also be used and bonded in the form of a single-sided (pressure-sensitive) adhesive tape with the corresponding carrier.

FIG. 4 shows a touch panel 5 bonded by means of a first pressure-sensitive adhesive tape 1 to a substrate 6, which is a plastic plate or a glass plate, for example. Applied to the touch panel 5 by means of a second pressure-sensitive adhesive tape 1 is then a top film 7, which typically has an anstiscratch coat.

FIG. 5 shows typical adhesive bonds for capacitive touch panels. For the bonding of structured ITO films 8, in particular, pressure-sensitive adhesive layers 2 with adhesive coat weights of greater than 50 g/m² are used, to provide for effective wetting of the structuring.

FIG. 5 additionally shows the bonding of a protective film or of a cellphone window 7, of a substrate 6 as rear reinforcement plate of a capacitive touch panel, and also of a display 9, with the PSA described. Both the PSA itself and the PSA in the form of an adhesive transfer tape may be used as a single-sided tape or else as a double-sided PSA tape with carrier film.

### Test Methods

### A. Bond Strength

The peel strength (bond strength) was tested in accordance with PSTC-101. The adhesive tape is applied to a glass plate. A strip of the adhesive tape, 2 cm wide, is bonded by being roiled over back and forth three times with a 2 kg roller. The plate is clamped in, and the self-adhesive strip is peeled via its free end on a tensile testing machine at a peel angle of 180° and at a speed of 300 mm/min, The force is reported in N/cm.

### B. Transmittance

The transmittance at 550 nm is determined in accordance with ASTM D1003. The specimen measured was the assembly made up of optically transparent PSA and glass plate.

### C. Haze

The haze is determined in accordance with ASTM D 1003.

### D. Light Stability

The assembly made up of PSA and glass plate, with a size of 4×20 cm², is irradiated for 250 hours using Osram Ultra Vitalux 300 W lamps at a distance of 50 cm. Following irradiation, the transmittance is determined by test method C.

### E. Climatic Cycling Test

The PSA is adhered as a single-sided adhesive tape (50 g/m² coat weight, 50 μm PET film of type Mitsubishi RNK 50) to a glass plate, without air bubbles. The dimensions of the test strip are 2 cm width and 10 cm length. The bond strength to glass is determined by test method A.

In parallel, an adhesive assembly of this kind is placed in a climatic cycling cabinet and stored for 1000 cycles. One cycle includes:
storage at −40° C. for 30 minutes
heating to 85° C. within 5 minutes
storage at 85° C. for 30 minutes
cooling to −40° C. within 5 minutes
   After the climatic cycling test, the bond strength is determined again by test method A.

### EXAMPLES

Coating operations in the examples took place on a conventional, laboratory coating unit for continuous coating, Coating was carried out in an ISO 5 clean room according to ISO standard 14644-1. The web width was 50 cm. The width of the coating gap was variably adjustable between 0 and 1 cm. The length of the heating tunnel was around 12 m. The temperature in the heating tunnel was divisible into four zones, and was freely selectable in each zone between room temperature and 120° C.

### Production of the Specimens:

The constituents are dissolved in toluene, giving a solids content of 30%. The mixture is distributed homogeneously by stirring. The specimens are then coated out onto a PET film 23 μm thick, and dried at 110° C., so as to leave a weight of adhesive per unit area of 50 g/cm.

The precise composition of the examples is evident from the breakdown below (figures, unless stated otherwise, in weight fractions).

### Example 1

A mixture of 100 g of Levapren™ 450, 30 g of Arkon™ P100, 0.3 g of Tinuvin™ 292, 0.3 g of Tinuvin™ 400 in solution in toluene (solids content 30% by weight) was coated out.

### Example 2

A mixture of 100 g of Levapren™ 450, 25 g of Arkon™ P100, 0.3 g of Tinuvin™ 292, 0.3 g of Tinuvin™ 400 in solution in toluene (solids content 30% by weight) was coated out.

### Example 3

A mixture of 100 g of Escorene™ Ultra EVA UL 05540EH2, 30 g of Arkon™ P100, 0.3 g of Tinuvin™ 292, 0.3 g of Tinuvin™ 400 in solution in toluene (solids content 30% by weight) was coated out.

### Example 4

A mixture of 100 g of Escorene™ Ultra EVA 04533EH2, 30 g of Arkon™ P100, 0.3 g of Tinuvin™ 292, 0.3 g of Tinuvin™ 400 in solution in toluene (solids content 30% by weight) was coated out.

### Example 5

A mixture of 100 g of Escorene™ Ultra EVA 04533EH2, 20 g of Arkon™ P100, 0.3 g of Tinuvin™ 292, 0.3 g of Tinuvin™ 400 in solution in toluene (solids content 30% by weight) was coated out.

Further details and properties of the raw materials employed:
Levapren™ 450 ethylene-vinyl acetate copolymer (EVA) having a vinyl acetate fraction of 45% by weight, from Lanxess
Escorene™ Ultra EVA 4533EHH2 ethylene-vinyl acetate copolymer (EVA) having a vinyl acetate fraction of 33.0% by weight, from Exxon Mobil Chemicals
Escorene™ Ultra. EVA UL 05540EH2 ethylene-vinyl acetate copolymer (EVA) having a vinyl acetate fraction of 39.0% by weight, from Exxon. Mobil Chemicals
Arcron P™ 100 rosin, pentaerythritol ester, softening range 100° C., from Arakawa Chemicals
Tinuvin™292 sterically hindered amine, light stabilizer, from Ciba
Tinuvin™406 triazine derivative, UV protectant, from Ciba

### RESULTS

To determine the technical bonding properties, the instantaneous bond strengths to glass of all of the inventive examples reference examples were ascertained. Measurement in this case took place at a 180° angle. The results are set out in table 1 below.

TABLE 1

| Example | Bond strength (Test A) |
|---|---|
| 1 | 5.2 N/cm |
| 2 | 4.9 N/cm |
| 3 | 4.4 N/cm |
| 4 | 4.6 N/cm |
| 5 | 3.9 N/cm |

From table 1 it is evident that all examples are suitable for permanent adhesive bonding and show relatively high bond strengths to glass, taking into account that the coat weight was only 50 g/m².

For further optical determination, measurements of transmittance and of haze were conducted on all of the examples. The results are listed in table 2.

TABLE 2

| | Transmittance | Haze |
|---|---|---|
| Example | (test B) | (test C) |
| 1 | 92% | 0.8% |
| 2 | 92% | 0.7% |
| 3 | 92% | 1.2% |
| 4 | 92% | 1.0% |
| 5 | 92% | 0.9% |

From table 2 it is apparent that all of the examples have a water-clear transparency and hence also a high transmittance. In the measurement, the transmittance is limited at around 92%, in each case as a result of reflection losses at the transition from air to the adhesive. These results are confirmed once again by the haze value measurements. Here again, haze values below 2% were measured in all cases.

Subsequently, furthermore, various aging investigations were carried out. First, a light stability test was carried out by test method D. This test examines whether long sunlight irradiation causes a discoloration or yellowing. This is particularly important for optical applications which are subject to long-term irradiation, such as by a display, for example, or are used in the exterior sector. The results are summarized in table 3.

TABLE 3

| | Transmittance after |
|---|---|
| | light stability test |
| Example | (Test D) |
| 1 | 91% |
| 2 | 91% |
| 3 | 91% |
| 4 | 91% |
| 5 | 91% |

From table 3 it is apparent that all of the examples have a stable transmittance and there is only a very little drop in the transmittance.

A further aging test includes climatic cycling. Here, the exposure of the adhesive to very different climatic conditions is simulated, as may in turn be the case for end applications in the cellphone segment. The alternating climate test was carried out by test method E. The results are set out in table 4.

TABLE 4

| | Bond strength after |
|---|---|
| | climatic cycling storage |
| Example | (Test E) |
| 1 | 4.9 N/cm |
| 2 | 4.7 N/cm |
| 3 | 4.4 N/cm |
| 4 | 4.2 N/cm |
| 5 | 3.6 N/cm |

The measurements from table 4 make it clear that the bond strengths after the climatic cycling test remain constant or drop only very slightly. The PSA compositions thus withstand intact the temperature loading in the climatic cycling test, and are therefore inter alia suitable for use in the consumer electronics segment.

1. A pressure-sensitive adhesive featuring a mixture at least comprising
an ethylene-vinyl acetate copolymer having an ethylene-vinyl acetate fraction of 30% to 70% by weight and
a rosin-pentaerythritol-based resin having a softening range of 80° C. to 120° C.,
the resin fraction being between 20% and 40% by weight, based on the ethylene-vinyl acetate copolymer,
the pressure-sensitive adhesive having a light transmittance to ASTM D 1003 of at least 86%, and the pressure-sensitive adhesive having a haze value to ASTM D 1003 of not more than 5%.

2. The pressure-sensitive adhesive as claimed in claim 1, characterized in that the ethylene-vinyl acetate fraction is at least 30%, preferably at least 40%, by weight and/or is not more than 70%, preferably not more than 60%, by weight.

3. The pressure-sensitive adhesive as claimed in claim 1 or 2, characterized in that said ethylene-vinyl acetate copolymer comprises mixtures of different ethylene-vinyl acetate copolymers.

4. The pressure-sensitive adhesive as claimed in any of the preceding claims, characterized in that, in addition to the ethylene-vinyl acetate copolymers, there are further comonomers present, more particularly acrylate monomers, preferably with a fraction of not more than 5% by weight, based on ethylene-vinyl acetate copolymers.

5. The pressure-sensitive adhesive as claimed in any of the preceding claims, characterized in that the resins are partially or fully hydrogenated.

6. The pressure-sensitive adhesive as claimed in any of the preceding claims, characterized in that it has a bond strength of at least 3.5 N/cm, preferably of at least 4.5 N/cm.

7. The pressure-sensitive adhesive as claimed in any of the preceding claims, characterized in that it has a light transmittance to ASTM D 1003 of at least 90%, preferably even after climatic cycling test E.

8. A pressure-sensitive adhesive tape having an adhesive layer and a carrier, characterized in that the adhesive layer comprises a pressure-sensitive adhesive as claimed in any of the preceding claims.

9. The pressure-sensitive adhesive tape as claimed in claim 8, characterized in that the carrier is in the form of a release film.

10. The pressure-sensitive adhesive tape as claimed in claim 8 or 9, characterized in that the coat weight of the pressure-sensitive adhesive is at least 5 g/m² and/or not more than 250 g/m².

11. The use of a pressure-sensitive adhesive as claimed in any of claims 1 to 10 for adhesively bonding optical components, more particularly optical films.

12. The use as claimed in claim 11, characterized in that the optical component is electrically conductive.
